(19) United States
(12) Patent Application Publication
(10) Pub. No.: US 2022/0382064 A1
(43) Pub. Date: Dec. 1, 2022

(54) METALENS FOR USE IN AN EYE-TRACKING SYSTEM OF A MIXED-REALITY DISPLAY DEVICE

(71) Applicant: Microsoft Technology Licensing, LLC, Redmond, WA (US)

(72) Inventors: David C. Rohn, Fort Collins, CO (US); Onur Can Akkaya, Los Altos, CA (US); James Peele Terrell, Jr., Bellevue, CO (US)

(21) Appl. No.: 17/336,071

(22) Filed: Jun. 1, 2021

(51) Int. Cl. G02B 27/01; G02B 1/00; G06F 3/01

(52) U.S. Cl. CPC G02B 27/0179; G02B 1/002; G02B 27/0172; G06F 3/013; G02B 2027/0187; G02B 2027/0178

(57) ABSTRACT

A head-mounted display device wearable by a user and supporting a mixed-reality experience includes a see-through display system through which the user can view a physical world and on which virtual images are renderable. At least one light source is configured to emit near infrared (IR) light that illuminates an eye of the user of the near-eye mixed reality display device. An imaging sensor is configured to capture reflections of the near IR light reflected from the eye of the user. A metalens is configured to receive the reflections of the IR light reflected from the eye of the user and direct the reflections onto the image sensor.

### BACKGROUND

Mixed-reality display devices, such as wearable head mounted mixed-reality (MR) display devices, may be configured to display information to a user about virtual and/or real objects in a field of view of the user and/or a field of view of a camera of the device. For example, an MR display device may be configured to display, using a see-through display system, virtual environments with real-world objects mixed in, or real-world environments with virtual objects mixed in.

In such MR display devices, tracking the positions of the eyes of a user can enable estimation of the direction of the user's gaze. Gaze direction can be used as an input to various programs and applications that control the display of images on the MR display devices, among other functions. To determine the position and gaze of the user's eyes, an eye tracker may be incorporated into the MR display device.

### SUMMARY

In an embodiment, an eye-tracking system is disposed in a near-eye mixed reality display device. The eye-tracking system includes one or more light sources configured to emit light in a specified waveband (e.g., the near-infrared) that illuminates an eye of a user of the near-eye mixed reality display device. An imaging sensor is configured to capture reflections of the light reflected from the eye of the user. A metalensmetalens is configured to receive the reflections of light from the eye of the user and direct the reflections onto the image sensor.

The implementation of an eye-tracking system that uses a metalensmetalens to receive the reflected light from the user's eye and direct it onto the image sensor provides significant technical advantages. In general, the use of a metalensmetalens allows for a higher performing eye-tracking system to be implemented in a smaller, potentially more energy efficient form factor. For example, metalensmetalenses are particularly well-suited for use in an eye-tracking system because such a system employs an illumination source with a predetermined and relatively narrow bandwidth which can be selected in advance as part of the system design process. In this way the metalens can be specifically tailored and optimized to operate at those wavelengths. As yet other examples of the advantages arising from the use of a metalens, a metalens can be thinner and lighter and have a greater sensitivity than its refractive counterpart. Additionally, the image quality provided by a metalensmetalens can be much better than that provided by a refractive lens when the metalensmetalens is matched with a suitable illumination source.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure. These and various other features will be apparent from a reading of the following Detailed Description and a review of the associated drawings.

### BRIEF DESCRIPTION OF THE DRAWINGS

FIG. 1 illustrates an example of a mixed reality (MR) display device.

FIG. 2 illustrates a block diagram of the MR display device illustrated in FIG. 1.

FIG. 3 illustratively shows holographic virtual images that are overlayed onto real-world images within a field of view (FOV) of a mixed reality device.

FIG. 4 shows one example of a sensor package which may be used in the eye tracking system of a mixed reality display device.

FIG. 5 shows a detail of an illustrative pattern of structures that collectively form the meta surface of the metalens shown in FIG. 4.

FIG. 6 illustrates another example of the mixed reality (MR) display device shown in FIG. 1 which employs both LEDs and VCSELs for performing both eye-tracking and iris recognition.

FIG. 7 is a flowchart showing one example of a method for operating an eye-tracking system in a near-eye display system.

FIG. 8 is a flowchart showing an example of a method for operating an eye-tracking system in a near-eye display system that employs both LED and VCSEL near IR light sources.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

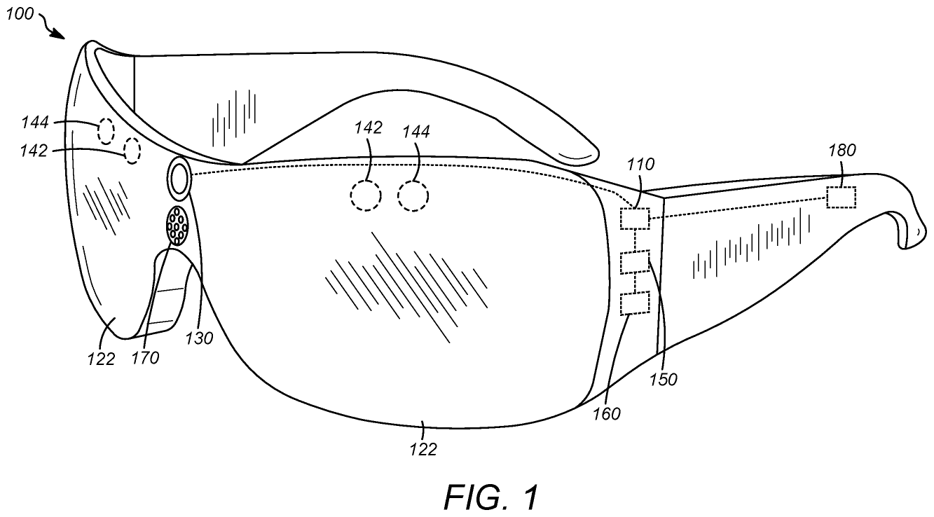

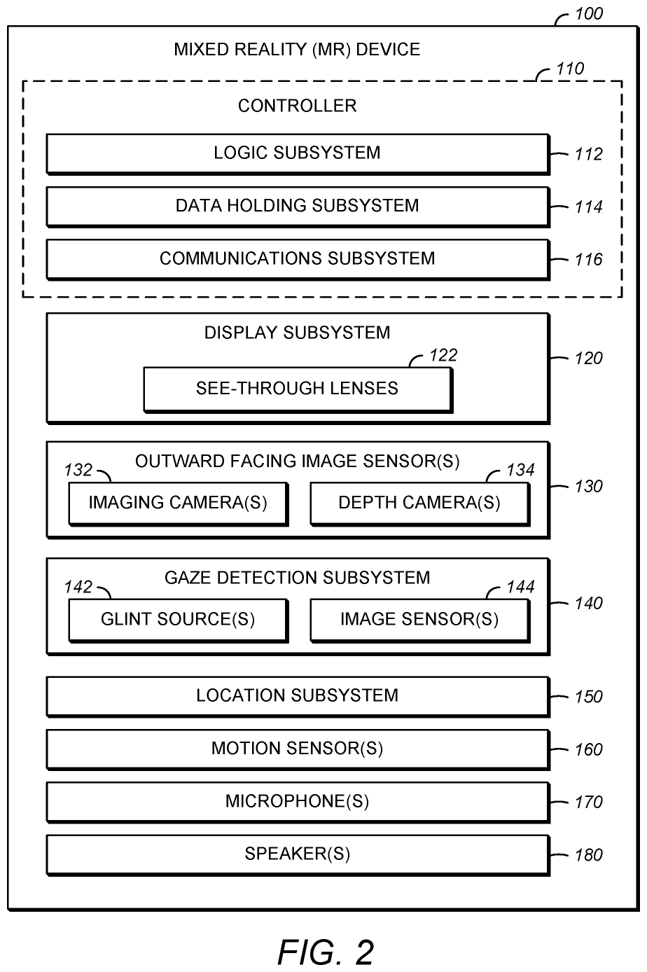

FIG. 1 illustrates an example of a mixed reality (MR) display device 100, and FIG. 2 illustrates a block diagram of the MR display device 100 illustrated in FIG. 1. In the example illustrated in FIGS. 1 and 2, the MR display device 100 is a head mounted MR device, intended to be worn on a user's head during ordinary use, including a head mounted display (HMD) device. However, it is noted that this disclosure is expressly not limited to head mounted MR devices or other near-eye display devices. Mixed reality refers to an experience allowing virtual imagery to be mixed with a real-world physical environment in a display. For example, real-world objects and/or real-world spaces may be identified and augmented with corresponding virtual objects. Mixed reality may be implemented with, for example, virtual reality or augmented reality technologies.

The MR display device 100 includes a display subsystem 120 for displaying images to a user of the MR display device 100. In the example illustrated in FIG. 1, the display subsystem 120 is intended to be close to a user's eyes and includes a see-through MR display device including one or more transparent or semi-transparent see-through lenses 122 arranged such that images may be projected onto the see-through lenses 122, or produced by image-producing elements (for example, see-through OLED displays) located within the see-through lenses 122. A user wearing the MR display device 100 has an actual direct view of a real-world space (instead of image representations of the real-world space) through the see-through lenses 122, and at the same time view virtual objects (which may be referred to as virtual images or holograms) that augment the user's direct view of the real-world space.

The MR display device 100 further includes one or more outward facing image sensors 130 configured to acquire image data for a real-world scene around and/or in front of the MR display device 100. The outward facing image sensors 130 may include one or more digital imaging camera(s) 132 arranged to capture two-dimensional visual images. In some implementations, two imaging camera(s) 132 may be used to capture stereoscopic images. The outward facing imaging sensors 130 may also include one or more depth camera(s) 134, such as, but not limited to, time of flight depth cameras, arranged to capture a depth image data, such as a depth map providing estimated and/or measured distances from the MR display device 100 to various portions of a field of view (FOV) of the depth camera(s) 134. Depth image data obtained via the depth camera(s) 134 may be registered to other image data, such as images concurrently captured via imaging camera(s) 132. The outward facing image sensors 130 may be configured to capture individual images and/or sequences of images (for example, at a configurable frame rate or frames rates). In some implementations, the outward facing image sensors 130 or other sensors associated with the MR display device 100 can be configured to assess and/or identify external conditions, including but not limited to time of day, direction of lighting, ambiance, temperature, and other conditions. The external conditions can provide the MR display device 100 with additional factor(s) to determine types of virtual graphical elements to display to a user.

The MR display device 100 may further include a gaze detection subsystem 140 configured to detect, or provide sensor data for detecting, a direction of gaze of each eye of a user, as illustrated in FIGS. 1 and 2. The gaze detection subsystem 140 may be arranged to determine gaze directions of each of a user's eyes in any suitable manner. For instance, in the example illustrated in FIGS. 1 and 2, the gaze detection subsystem 140 includes one or more glint sources 142, such as infrared (IR) light sources, arranged to cause a glint of light to reflect from each eyeball of a user, and one or more image sensor(s) 144 arranged to capture an image of each eyeball of the user. Changes in the glints from the user's eyeballs as determined from image data gathered via image sensor(s) 144 may be used to determine a direction of gaze. Further, a location at which gaze lines projected from the user's eyes intersect the external display may be used to determine an object or position at which the user is gazing (for example, a virtual object displayed by the display subsystem 120). The gaze detection subsystem 140 may have any suitable number and arrangement of glint sources and image sensors. In one non-limiting example embodiment, four glint sources and one image sensor are used for each eye. Furthermore, in some implementations, the gaze detection subsystem 140 can be configured to assist the MR display device 100 in more accurately identifying real-world objects of interest and associating such objects with virtual applications.

The MR display device 100 may include a location subsystem 150 arranged to provide a location of the MR display device 100. Location subsystem 150 may be arranged to determine a current location based on signals received from a navigation satellite system, such as, but not limited to, GPS (United States), GLONASS (Russia), Galileo (Europe), and CNSS (China), and technologies augmenting such signals, such as, but not limited to, augmented GPS (A-GPS). The location subsystem 150 may be arranged to determine a location based on radio frequency (RF) signals identifying transmitting devices and locations determined for such devices. By way of example, Wi-Fi, Bluetooth, Zigbee, RFID, NFC, and cellular communications include device identifiers that may be used for location determination. MR display device 100 may be arranged to use a location provided by the location subsystem 150 as an approximate location, which is refined based on data collected by other sensors. The MR display device 100 may include audio hardware, including one or more microphones 170 arranged to detect sounds, such as verbal commands from a user of the MR display device 100, and/or one or more speaker(s) 180 arranged to output sounds to the user, such as verbal queries, responses, instructions, and/or information.

The MR display device 100 may include one or more motion sensor(s) 160 arranged to measure and report motion of the MR display device 100 as motion data. In some implementations, the motion sensor(s) 160 may include an inertial measurement unit (IMU) including accelerometers (such as a 3-axis accelerometer), gyroscopes (such as a 3-axis gyroscope), and/or magnetometers (such as a 3-axis magnetometer). The MR display device 100 may be arranged to use this motion data to determine changes in position and/or orientation of MR display device 100, and/or respective changes in position and/or orientation of objects in a scene relative to MR display device 100. The outward facing image sensor(s) 130, image sensor(s) 144, sensors included in the location subsystem 150, motion sensor(s) 160, and microphone(s) 170, which are included in or are coupled to the head mounted MR display device 100, may be, individually or collectively, referred to as head mounted sensors. Data collected via such head mounted sensors reflect the position and orientations of a user's head.

The MR display device 100 further includes a controller 110 including a logic subsystem 112, a data holding subsystem 114, and a communications subsystem 116. The logic subsystem 112 may include, for example, one or more processors configured to execute instructions and communicate with the other elements of the MR display device 100 illustrated in FIGS. 1 and 2 according to such instructions to realize various aspects of this disclosure involving the MR display device 100. Such aspects include, but are not limited to, configuring and controlling devices, processing sensor input, communicating with other computer systems, and/or displaying virtual objects via display subsystem 120. The data holding subsystem 114 includes one or more memory devices (such as, but not limited to, DRAM devices) and/or one or more storage devices (such as, but not limited to, flash memory devices). The data holding subsystem 114 includes one or more media having instructions stored thereon which are executable by the logic subsystem 112, which cause the logic subsystem 112 to realize various aspects of this disclosure involving the MR display device 100. Such instructions may be included as part of an operating system, application programs, or other executable programs. The communications subsystem 116 is arranged to allow the MR display device 100 to communicate with other computer systems. Such communication may be performed via, for example, Wi-Fi, cellular data communications, and/or Bluetooth.

It will be appreciated that the MR display device 100 is provided by way of example, and thus is not meant to be limiting. Therefore, it is to be understood that the MR display device 100 may include additional and/or alternative sensors, cameras, microphones, input devices, output devices, etc. than those shown without departing from the scope of this disclosure. Further, the physical configuration of an MR device and its various sensors and subcomponents may take a variety of different forms without departing from the scope of this disclosure.

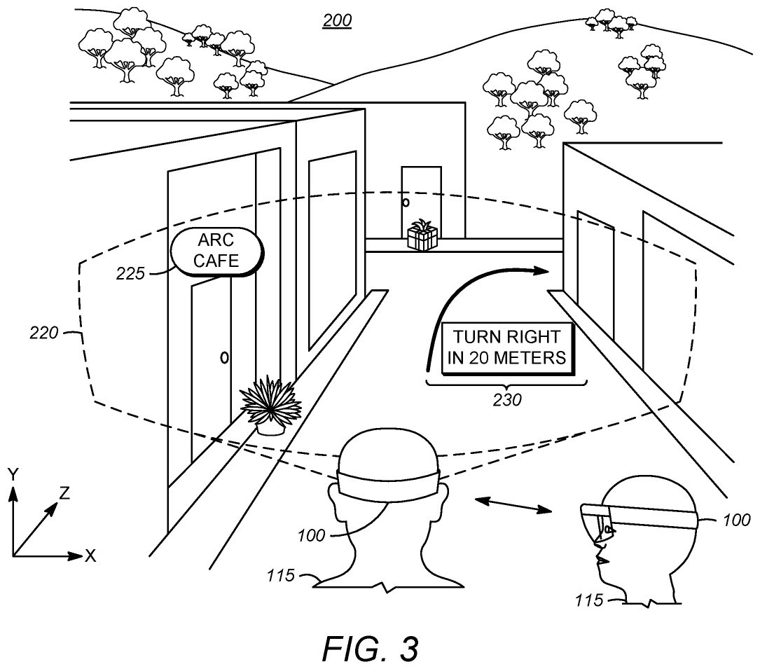

FIG. 3 illustrates a example of a user 115 making use of an MR display device 100 in a physical space. As noted above, an imager (not shown) generates holographic virtual images that are guided by the waveguide(s) in the display device to the user. Being see-through, the waveguide in the display device enables the user to perceive light from the real world.

The display subsystem 120 of the MR display device 100 can render holographic images of various virtual objects that are superimposed over the real-world images that are collectively viewed to thereby create a mixed-reality environment 200 within the MR display device's FOV (field of view) 220. It is noted that the FOV of the real world and the FOV of the holographic images in the virtual world are not necessarily identical, as the virtual FOV provided by the display device is typically a subset of the real FOV. FOV is typically described as an angular parameter in horizontal, vertical, or diagonal dimensions.

It is noted that FOV is just one of many parameters that are typically considered and balanced by MR display device designers to meet the requirements of a particular implementation. For example, such parameters may include eyebox size, brightness, transparency and duty time, contrast, resolution, color fidelity, depth perception, size, weight, form-factor, and user comfort (i.e., wearable, visual, and social), among others.

In the illustrative example shown in FIG. 3, the user 115 is physically walking in a real-world urban area that includes city streets with various buildings, stores, etc., with a countryside in the distance. The FOV of the cityscape viewed on MR display device 100 changes as the user moves through the real-world environment and the device can render static and/or dynamic virtual images over the real-world view. In this illustrative example, the holographic virtual images include a tag 225 that identifies a restaurant business and directions 230 to a place of interest in the city. The mixed-reality environment 200 seen visually on the waveguide-based display device may also be supplemented by audio and/or tactile/haptic sensations produced by the MR display device in some implementations.

In a wearable device such as MR display device 100, estimating the position of a user's eye can allow the MR display device to display images according to where the user's eye is located and in which direction the user is looking. The user may also interact with the MR display device by using their gaze as input to command the MR display device. For this purpose gaze detection subsystem 310 is used to determine the position and gaze of the user's eye.

As previously mentioned, gaze detection may be accomplished using one or more IR light sources that cause a glint of light to be reflected from each of the user's eyes. The glint of light is then detected by an image sensor (e.g., image sensor 134 shown in FIG. 1). The IR light sources (e.g., glint sources 132 in FIG. 1) are typically light emitting diodes (LEDs) sources that operate at near infrared (IR) wavelengths e.g., wavelengths between about 750 nm and 2500 nm. A lens or lens system is generally incorporated in or otherwise associated with the image sensor to focus the light onto the sensor. In some case the lens may form a telecentric image. That is, the metalens may be telecentric in image space.

In a conventional gaze detection system the sensor lens is typically a refractive lens in which control of light characteristics such as amplitude, direction and polarization is determined by the lens geometry and the intrinsic material properties of the lens. For example, the refractive index of a conventional lens is determined by its refractive index, which is based at least in part on the lens material. In the embodiments described herein, the sensor lens is implemented from one or more elements formed of metamaterials. In general, an optical metamaterial (also referred to as a photonic metamaterial) can be defined as any composition of sub-wavelength structures arranged to modify the optical response of an interface. That is, in an optical metamaterial, the optical response depends on the arrangement of the sub-wavelength structures. Accordingly, metamaterials can be engineered to exhibit optical properties not otherwise available in other naturally occurring materials. An element having a meta surface structure for controlling the optical response of light is sometimes referred to as a metalensmetalens or simply a metalens.

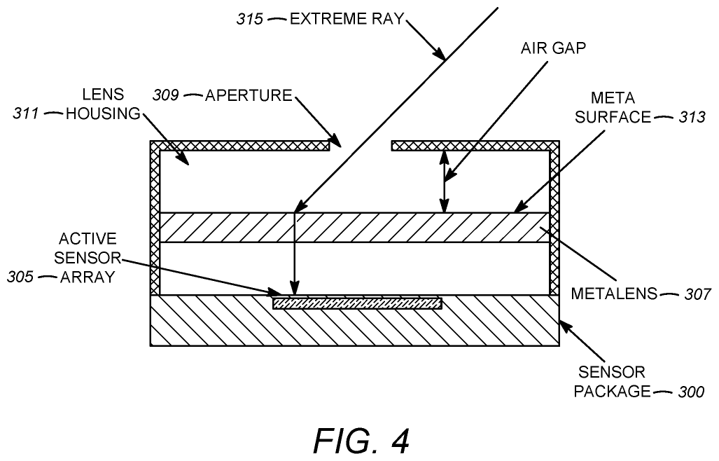

FIG. 4 shows one example of a sensor package 300 which may be used in the eye tracking system of a mixed reality device. The sensor package 300 includes a sensor array 305 such as a CMOS sensor and a metalens 307. An aperture 309 in the sensor housing 311 allows NIR light reflected from the user's eye to be incident on the meta surface 313 of the metalens 307, which directs the light onto the sensor array 305.

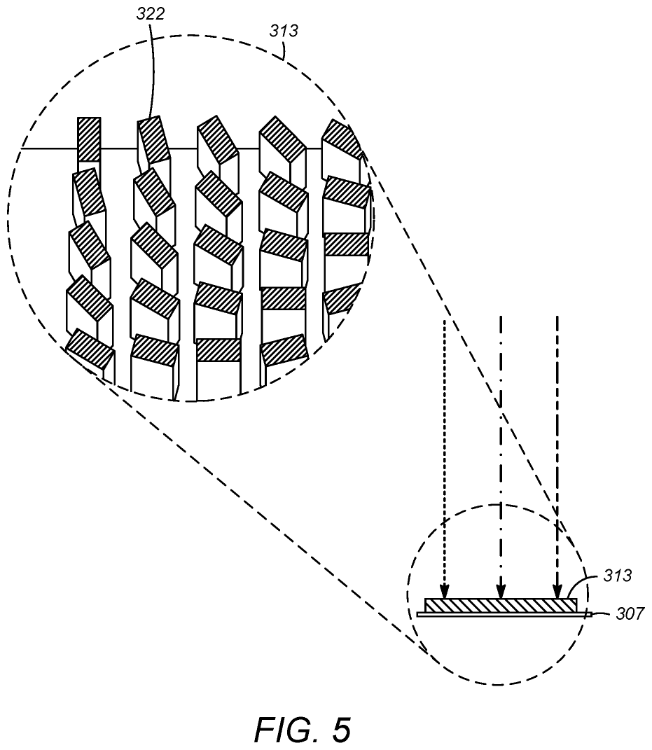

The meta surface 313 can include a dense arrangement of sub-wavelength structures arranged to introduce a phase shift in an incident wavefront, thereby allowing for precise control of the deflection of light rays. For example, FIG. 5 shows a detail of a pattern of structures 322 that collectively form the meta surface 313 of the metalens 307. The example structures depicted in the detail are shown with exaggerated features for illustrative purposes. The details are not intended to impart limitations with respect to the number, shape, arrangement, orientation, or dimensions of the features of the corresponding optical element. In other embodiments, meta surface 313 may have different structure patterns. The metalens 307 can be designed to deflect the NIR wavelengths of an incident light ray onto the sensor array 305, as indicated in FIG. 3 by extreme ray 315. It should be noted that the example arrangement of structures 322 depicted in the detail are shown for illustrative purposes and do not necessarily represent an arrangement suited for a particular image sensor.

The design and manufacture of a metalens for a particular wavelength is known in the art, and any of those known design methods for forming nanostructures on a metalensmetalens for a particular wavelength may be utilized in conjunction with the image sensor described herein for use with a gaze detection system such as described above. For example, the reference Amir Arbabi, et al., Miniature optical planar camera based on a wide-angle metasurface doublet corrected for monochromatic aberrations, Nature Communications 7, Article number: 13682 (2016), sets forth design principles and manufacturing techniques suitable for use with the present technology.

It is well-known that metalensmetalenses generally exhibit poor performance across broad wavelength bands and perform well for a single wavelength or narrow band of wavelengths, with the performance degrading quickly as the bandwidth increases. That is, metalenses suffer from relatively large chromatic aberrations. This characteristic of metalenses can make them problematic when used with relatively broadband light sources. For instance, the image quality provided by a camera having a metalens may be poor when the camera is used to capture an image of an object or scene illuminated with ambient light (e.g., sunlight, interior lighting). The present inventors have recognized, however, that metalenses are particularly well-suited for use in cameras or other imaging devices that capture an image using an active light source that has a narrow bandwidth which can be selected in advance as part of the system design process so that the metalens can be specifically tailored to operate at those wavelengths.

Moreover, in addition to their overall compatibility with an imaging device employing active illumination, a number of significant advantages arise from the use of a metalens in the gaze-detection system of an MR device such as a head-mounted MR device. For example, a metalens can be thinner and lighter than its refractive counterpart, which is particularly important in a device designed for portability such as a head-mounted MR device. Also, despite its susceptibility to high chromatic dispersion, the image quality provided by a metalens can be much better than that provided by a refractive lens when the metalens is matched with a suitable illumination source.

Yet another advantage of a metalens is that it can be designed with a lower f-number than its refractive counterpart, which increases its sensitivity at low light levels, thereby reducing the power requirements of the illumination source, which once again is particularly important in a portable device such as a head-mounted MR device. Other advantages of a metalens includes its thermal stability and various manufacturing advantages such as the ability to relatively easily apply an anti-reflective coating to the flat surface opposite the metasurface of the lens.

While the example of a head-mounted MR device described above has been described as having a gaze detection system that employs an image sensor with a metalens, more generally the head-mounted MR device may be equipped with any type of eye-tracking system that employs an image sensor having a metalens. Such eye-tracking systems may be used for gaze detection and/or pupil position tracking and imaging for e.g., iris recognition for biometric identification or authentication. One particular embodiment of an eye-tracking system that can be used for both gaze detection and/or pupil position tracking and imaging will be discussed below.

In some embodiments the light source is a light emitting diode (LED) operating at near IR wavelengths. In an alternative embodiment the light source may be a vertical-cavity surface-emitting laser (VCSEL), which may be advantageous because it can be designed to be suitably compact and energy efficient, while emitting a narrower band of wavelengths than an LED operating at near IR wavelengths. For example, while an LED operating at near IR wavelengths may have a bandwidth of about e.g., 50 nm at near IR wavelengths, a VCSEL may have a bandwidth of about e.g., 5 nm, at near IR wavelengths. In addition to the aforementioned advantages arising from the use of a VCSEL, they also may be advantageous because the use of a narrower bandwidth can produce a higher quality image since the metalens will suffer less chromatic dispersion. In addition, the use of a narrower bandwidth can improve IR ambient light coexistence since interference may be reduced from reflections of ambient light and stray ambient light from the eye, which can compete with the light from the narrowband, near IR light source.

When LEDs are used, they serve as glint sources, which, as explained above, cause a glint of light to reflect from each eye of a user, allowing the user's direction of gaze to be determined. However, the resolution or sharpness of the image produced using LEDs is generally not sufficient for performing iris recognition. However, because of the improved image quality that can be produced when VCSELs are used, an eye tracking system using a VCSEL as the light source and a metalens that is used with the image sensor can be collectively used to perform iris recognition in addition to gaze detection.

In yet another embodiment, a hybrid approach may be employed in which both one or more LEDs and one or more VCSELs are provided as light sources for the eye tracking system. The LEDs may be used when the user's direction of gaze is to be determined. And the VCSELs may be used when a high-resolution image is required (e.g., for iris recognition). Hence, only the LEDs or the VCSELs may need to be supplied with power at any one time.

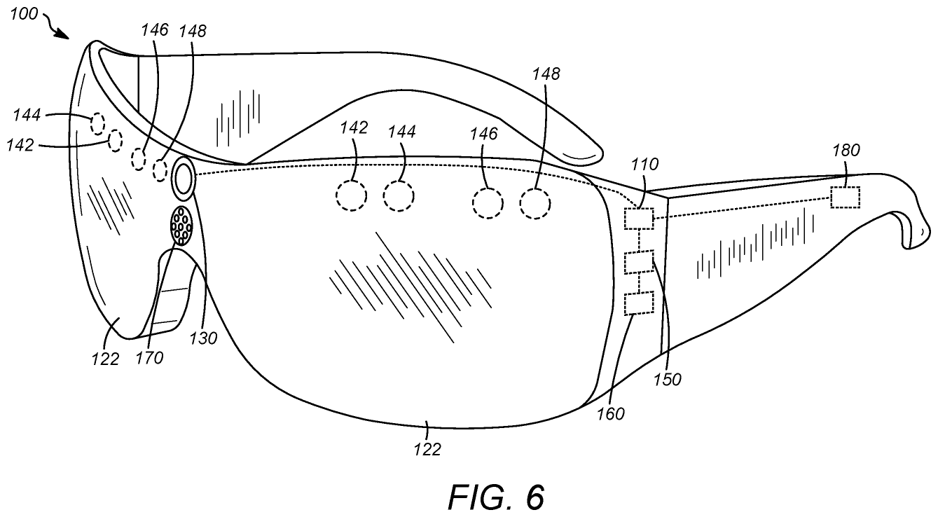

FIG. 6 shows an alternative example of the MR display device shown in FIG. 1. In FIGS. 1 and 6 like elements are denoted by like reference numbers. The device in FIG. 6 employs LED sources 142 and 144 as shown in FIG. 1 as well VCSEL sources 146 and 148. It should be noted that the number of LED and VCSEL light sources, as well their placement on the frame of the device may vary and that the number of light sources and their location in FIG. 6 are shown for illustrative purposes only. Moreover, the number of LED sources and VCSEL sources need not necessarily be the same.

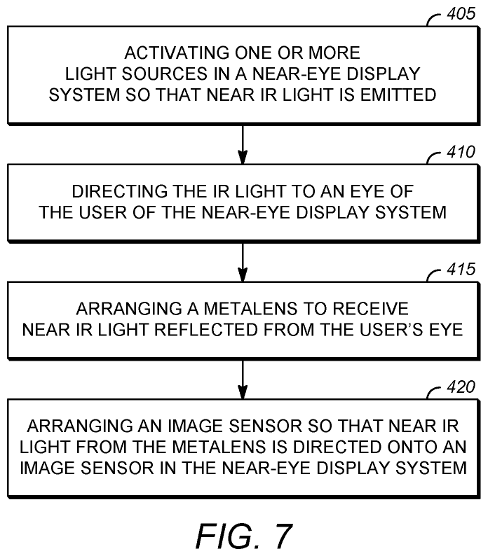

FIG. 7 is a flowchart showing one example of a method for operating an eye-tracking system in a near-eye display system that employs a single type of near IR light source (e.g., LED or VCSEL). At step 405 one or more light sources in the near-eye display system is activated so that near IR light is emitted. At step 410 the light is directed to an eye of the user of the near-eye display system. A metalens is arranged at step 415 to receive near IR light reflected from the user's eye. The metalens has a meta surface with sub-wavelength structures having a configuration and arrangement for directing the reflections onto the image sensor which is determined based at least in part on the prescribed waveband. An image sensor is arranged in the near-eye display system so that the reflected near IR light received by the metalens is directed by the metalens onto an image sensor.

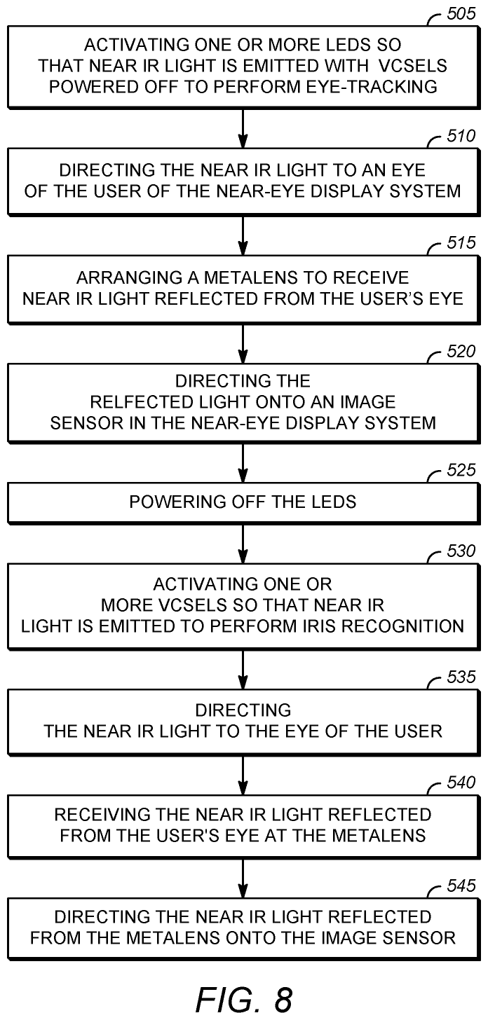

FIG. 8 is a flowchart showing an example of a method for operating an eye-tracking system in a near-eye display system that employs both LED and VCSEL near IR light sources. In this example the eye-tracking system is first used for eye tracking and then for iris tracking, although more generally the system may be used in any sequence to perform eye tracking and iris tracking or it may be used to perform only one of eye tracking or iris tracking. At step 505 the one or more LEDs in the near-eye display system are activated so that near IR light is emitted and the VCSELs are powered off. At step 510 the near IR light is directed to an eye of the user of the near-eye display system. A metalens is arranged at step 515 to receive near IR light reflected from the user's eye. The metalens directs the reflections onto an image sensor at step 520. This results in a low modulation transfer function (MTF) image that is sufficient for eye tracking. After the image is obtained the LEDs may be powered off at step 525.

Next, at step 530, when it is desired to perform iris recognition, the one or more VCSELs in the near-eye display system are activated so that relatively narrowband near IR light is emitted. The LEDs remain off. At step 535 the near IR light is directed to the eye of the user. The metalens receives the near IR light reflected from the user's eye at step 540. The metalens directs the reflections onto the image sensor at step 545 to form an image. Since the output from the VCSELs is relatively narrowband, a high modulation transfer function (MTF) image is formed that is generally sufficient for iris recognition.

Various exemplary embodiments of the present display system are now presented by way of illustration and not as an exhaustive list of all embodiments. An example includes a method for operating a near-eye display system, comprising: illuminating an eye of a user of the near-eye display system with light from at least one light source emitting light in a prescribed waveband; and capturing reflections of the light from the eye of the user using an image sensor arrangement that includes a metalens that receives the reflections of light and directs the reflections of light onto an image sensor.

In another example the metalens has a meta surface with sub-wavelength structures having a configuration and arrangement for directing the reflections onto the image sensor which is determined based at least in part on the prescribed waveband. In another example illuminating the eye of the user includes activating at least one LED to illuminate the eye of the user. In another example illuminating the eye of the user includes activating at least one VCSEL to illuminate the eye of the user. In another example illuminating the eye of the user includes selectively activating a first set of light sources for performing user gaze detection and selectively activating a second set of light sources different from the first set of light sources for performing iris recognition. In another example selectively activating the first set of light sources and selectively activating the second set of light sources includes only activating one of the first set of light sources and the second set of light sources at any given time. In another example the light sources in the first set of light sources are configured to emit a narrower bandwidth of light than the light sources in the second set of light sources. In another example the first set of light sources includes at least one LED and the second set of light sources includes at least one VCSEL. In another example the specified waveband is a near Infrared (IR) waveband. In another example the near-eye display system includes a mixed-reality (MR) display device. In another example the metalens is configured to operate as a telecentric lens.

A further example includes an eye-tracking system disposed in a near-eye mixed reality display device, comprising: at least one light source configured to emit light in a specified waveband that illuminates an eye of a user of the near-eye mixed reality display device; an imaging sensor configured to capture reflections of the light reflected from the eye of the user; and a metalens configured to receive the reflections of the light reflected from the eye of the user and direct the reflections onto the image sensor, the metalens having a meta surface with sub-wavelength structures having a configuration and arrangement for directing the reflections onto the image sensor which is determined based at least in part on the specified waveband.

In another example the at least one light source includes a light emitting diode (LED) or a vertical-cavity surface-emitting laser (VCSEL). In another example the at least one light source includes at least one LED and at least one VCSEL. In another example the at least one light source includes at least first and second light sources, the first light source being configured to emit a narrower bandwidth of light than the second light source. In another example the specified waveband is a near Infrared (IR) waveband. In another example the metalens is configured to operate as a telecentric lens.

A further example includes a head-mounted display device wearable by a user and supporting a mixed-reality experience, comprising: a see-through display system through which the user can view a physical world and on which virtual images are renderable; at least one light source configured to emit near IR light that illuminates an eye of the user of the near-eye mixed reality display device; an imaging sensor configured to capture reflections of the near IR light reflected from the eye of the user; and a metalens configured to receive the reflections of the IR light reflected from the eye of the user and direct the reflections onto the image sensor.

In another example the metalens has a meta surface with sub-wavelength structures being configured and arranged for operation at near IR wavelengths. In another example the at least one light source includes at least first and second light sources, the first light source being configured to emit a narrower bandwidth of light than the second light source.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method for operating a near-eye display system, comprising:
illuminating an eye of a user of the near-eye display system with light from at least one light source emitting light in a prescribed waveband, wherein illuminating the eye of the user includes selectively activating a first set of light sources that includes at least one light emitting diode (LED) for performing user gaze detection and selectively activating a second set of light sources different from the first set of light sources and which includes at least one vertical-cavity surface-emitting laser (VCSEL) for performing iris recognition; and
capturing reflections of the light from the eye of the user using an image sensor arrangement that includes a metalens that receives the reflections of light and directs the reflections of light onto an image sensor.

2. The method of claim 1, wherein the metalens has a meta surface with sub-wavelength structures having a configuration and arrangement for directing the reflections onto the image sensor which is determined based at least in part on the prescribed waveband.

3. The method of claim 1, wherein illuminating the eye of the user includes activating at least one LED to illuminate the eye of the user.

4. The method of claim 1, wherein illuminating the eye of the user includes activating at least one vertical-cavity surface-emitting laser (VCSEL) to illuminate the eye of the user.

5. (canceled)

6. The method of claim 1, wherein selectively activating the first set of light sources and selectively activating the second set of light sources includes only activating one of the first set of light sources and the second set of light sources at any given time.

7. (canceled)

8. (canceled)

9. The method of claim 1, wherein the specified waveband is a near Infrared (IR) waveband.

10. The method of claim 1, wherein the near-eye display system includes a mixed-reality (MR) display device.

11. The method of claim 1, wherein the metalens is configured to operate as a telecentric lens.

12. An eye-tracking system disposed in a near-eye mixed reality display device, comprising:
at least one light source configured to emit light in a specified waveband that illuminates an eye of a user of the near-eye mixed reality display device, wherein the at least one light source includes a first set of light sources having at least one light emitting diode (LED) for performing user gaze detection and a second set of light sources different from the first set of light sources and which includes at least one vertical-cavity surface-emitting laser (VCSEL) for performing iris recognition;
an imaging sensor configured to capture reflections of the light reflected from the eye of the user; and
a metalens configured to receive the reflections of the light reflected from the eye of the user and direct the reflections onto the image sensor, the metalens having a meta surface with sub-wavelength structures having a configuration and arrangement for directing the reflections onto the image sensor which is determined based at least in part on the specified waveband.

13. (canceled)

14. (canceled)

15. (canceled)

16. The eye-tracking system of claim 12, wherein the specified waveband is a near Infrared (IR) waveband.

17. The eye-tracking system of claim 12, wherein the metalens is configured to operate as a telecentric lens.

18. A head-mounted display device wearable by a user and supporting a mixed-reality experience, comprising:
a see-through display system through which the user can view a physical world and on which virtual images are renderable;
at least one light source configured to emit near infrared (IR) light that illuminates an eye of the user of the near-eye mixed reality display device, wherein the at least one light source includes a first set of light sources having at least one light emitting diode (LED) for performing user gaze detection and a second set of light sources different from the first set of light sources and which includes at least one vertical-cavity surface-emitting laser (VCSEL) for performing iris recognition;
an imaging sensor configured to capture reflections of the near IR light reflected from the eye of the user; and
a metalens configured to receive the reflections of the IR light reflected from the eye of the user and direct the reflections onto the image sensor.

19. The head-mounted display device of claim 18, wherein the metalens has a meta surface with sub-wavelength structures being configured and arranged for operation at near infrared (IR) wavelengths.

20. (canceled)
